(19) United States
(12) Patent Application Publication
(10) Pub. No.: US 2009/0025648 A1
(43) Pub. Date: Jan. 29, 2009

(54) PET TOY HAVING NOISE MAKING CHARACTERISTICS

(76) Inventor: Allen Simon, New York, NY (US)

Correspondence Address: DARBY & DARBY P.C., P.O. BOX 770, Church Street Station, New York, NY, 10008-0770, US

(21) Appl. No.: 12/178,394

(22) Filed: Jul. 23, 2008

Related U.S. Application Data
(60) Provisional application No. 60/951,347, filed on Jul. 23, 2007.

(51) Int. Cl. A01K 29/00

(52) U.S. Cl. 119/707

(57) ABSTRACT

A noise making animal toy having a sealed vessel having a resilient wall that can be deformed when an animal applies pressure to the toy, e.g., by chewing or pouncing on the toy is disclosed. The deformation of the wall of the vessel by application of force produces a noise, which can best be described as a crunching and/or crackling sound, which entertains the animal. The toy includes an outer durable fabric shell enclosing the vessel. The vessel may be made from a plastic beverage bottle.

### CROSS REFERENCE TO RELATED APPLICATION

The present application claims priority under 35 U.S.C. § 119(e) to U.S. Provisional Patent Application No. 60/951,347, which was filed on Jul. 23, 2007 and is hereby incorporated by reference herein in its entirety.

### BACKGROUND OF THE INVENTION

1. Field of the Invention

This invention relates generally to a toy, and more particularly to a toy for a domestic animal.

2. Discussion of the Related Art

There are numerous toys of various types available for pets. However, some of these toys prove to be uninteresting to the pets and they are not used. Either the pets will not interact with the toy at all, or after a short period of interaction, the toy is discarded. Some attempts have been made to increase the appeal of these toys so that the pets will interact with the toys for a much longer period of time, such as by placing food items within the toy. However, once the animal is successful in removing the food from the toy, the animal loses interest. These toys require the food items to be replenished, which is inconvenient and often messy.

The purpose of the invention is to provide a toy for a domestic animal which produces a noise when the toy is chewed that encourages the animal to continue playing with the toy.

### SUMMARY OF THE INVENTION

A noise making animal toy comprises a sealed vessel having a resilient wall that can be deformed when an animal applies pressure to the toy, e.g., by chewing or pouncing on the toy. At least a portion of the vessel wall is formed so that it bends in and out to form a textured surface. The deformation of the wall of the vessel by application of force produces a noise, which can best be described as a crunching and/or crackling sound. The toy includes a sheet of resilient material provided around at least a portion of the vessel and an outer durable fabric shell enclosing the resilient material and the vessel. The vessel is made from a durable resilient material

### BRIEF DESCRIPTION OF THE DRAWINGS

FIG. 1 is an exploded perspective view of a domestic animal toy according to a preferred embodiment of the invention;

FIG. 2 is an perspective view thereof;

FIG. 3 is a cross sectional view taken along line 3-3 of FIG. 2;

FIG. 4 is a front view of the core portion of the toy; and

FIG. 5 is a cross sectional view taken along line 5-5 of FIG. 4.

### DETAILED DESCRIPTION OF THE PREFERRED EMBODIMENTS

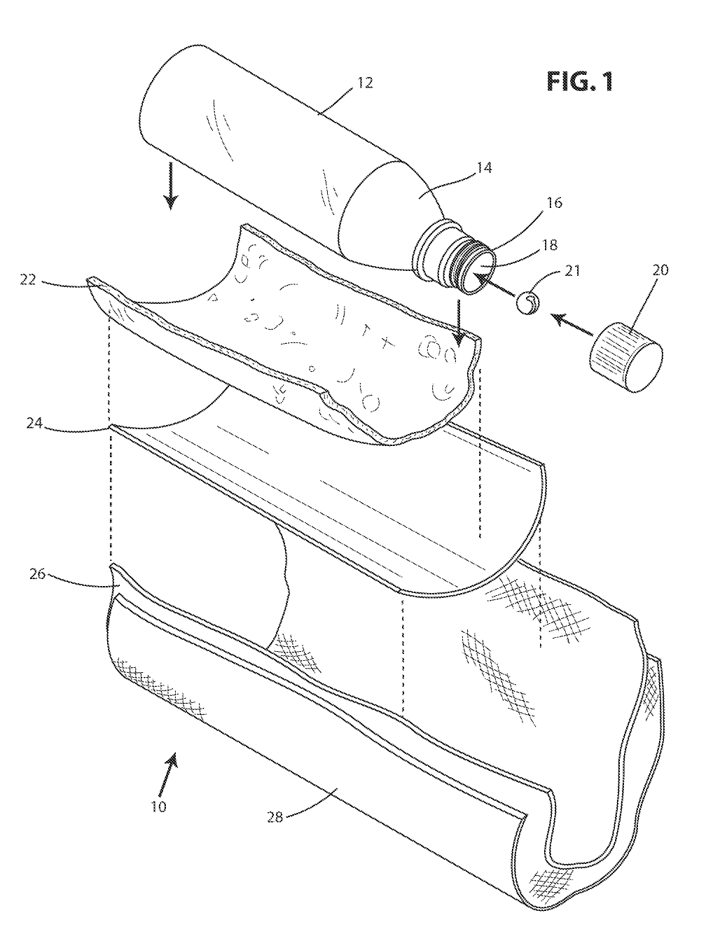

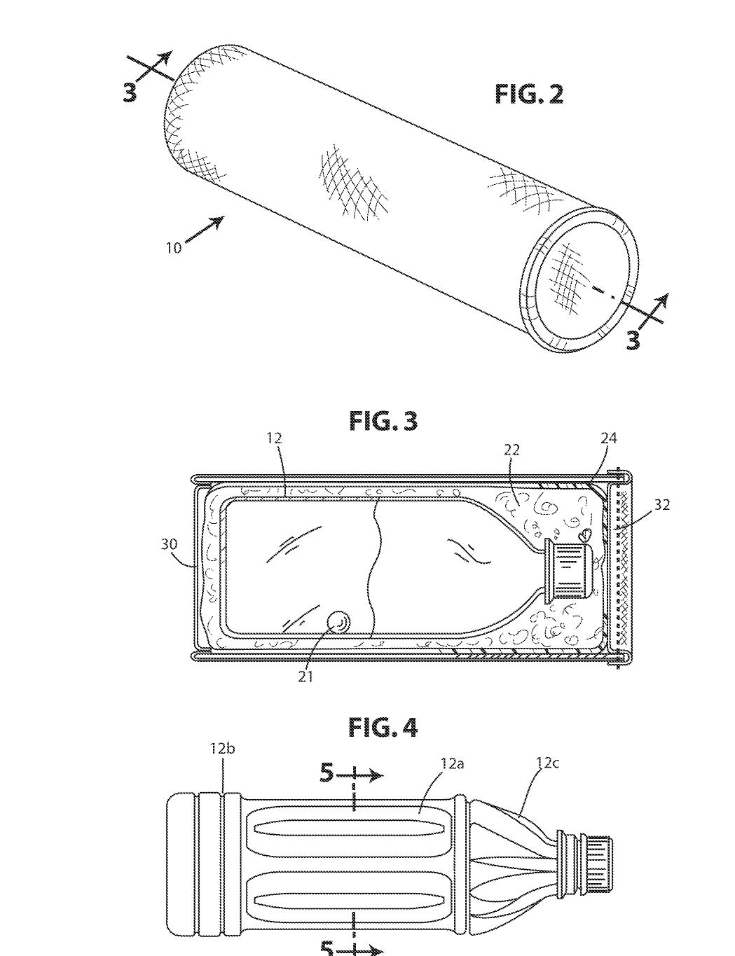

In an embodiment of the invention, as shown in exploded view in FIG. 1, the noise making pet toy 10, which is intended to be chewed by a domestic animal, includes a core 12, padding material 22, resilient material 24, inner cover 26, and outer shell 28. When the animal chews the toy 10, the core 12 is resiliently deformed, which produces a noise such as a crunching and crackling sound that encourages the animal to continue to chew the toy 10.

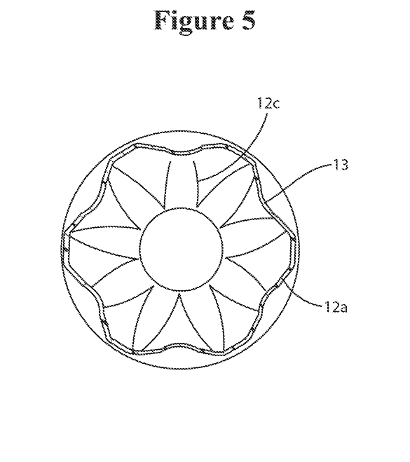

The core 12 is a sealed vessel made from a durable plastic material and is preferably made from PET plastic material. For example, core 12 is an empty plastic drink container, such as a soda bottle or the like. As shown in FIG. 1, the core 12 is configured in a cylindrical shape with a neck portion 14, a threaded end portion 16, an opening 18 to the interior of the core, and a threaded screw cap 20. As shown in FIGS. 4 and 5, the core 12 has a textured surface. The textured surface areas 12A, 12B, and 12C are local regions of highs and lows in the surface of the core 12. As can be seen in FIG. 5, wall 13 of the core 12 is formed so that it bends in and out, or undulates, to form the textured surface areas 12A-12C. The wall 13 can be formed with various indentations and embossments to provide a variety of types of textured surfaces.

The textured surface areas 12A-12C enhance the noise created by the toy when it is chewed or other force is applied as the pet plays with the toy. As the toy is chewed, the wall 13 of core 12 is deformed, and when the animal releases the toy, the durable and resilient core 12 substantially returns to its undeformed condition. Essentially, pressure is locally applied to an area of the vessel wall 13 (e.g., by teeth) until the vessel wall 13 locally buckles, which produces a sound. When the pressure is removed, the vessel wall snaps back into place, which produces another sound. As the core 12 is deformed and undeformed, the wall 13 bends in and out which creates sounds which can best be described as a crunching and crackling sound. The crunching and crackling sound greatly enhances the appeal of the toy to the pet. Additionally, the shape of the surface texture 12A-12C affects the characteristics of the sound produced. Region 12A produces a relatively lower pitch sound when deformed and undeformed, and regions 12B and 12C produce a relatively higher pitch sound.

The core 12 is sealed by screw cap 20 with air inside, preferably at atmospheric pressure, so that when the core 12 is deformed when the animal chews on it, the air sealed inside helps the core to substantially return to its original, undeformed shape when the animal releases it. It is to be understood that the core 12 may not completely return to its undeformed shape and the core may sustain some permanent deformation. The core need only be resilient enough so that when the core is deformed and then released, it at least partially undeforms so that the core may be repeatedly deformed to produce the desired sounds. Thus, the core can undergo a number of cycles of deformation and make the crunching and crackling sounds.

The sealed core 12 can be opened by removing the threaded end cap 20 so that items to be placed inside the core 12, such as bell 21. The threaded end cap 20 is placed onto the threaded end portion 16 in order to seal the core 12. Other items may be placed inside the core 12, such as a small amount of sand or water so that the toy 10 may be thrown farther and the trajectory and bounce characteristics are less predictable, thereby adding to the entertainment value of the toy 10.

As shown in FIG. 3, the toy 10 includes padding material 22 that is placed around the core 12. The padding material 22 is placed around the core 12 in order to give the toy 10 a desired, uniform shape, such as a cylinder. The padding material 22 may be any filler material such as cotton wadding or synthetic materials. The padding material 22 can be provided around the body of the core 12 and the neck portion 14, as shown in FIG. 3, or the padding material 22 may be provided only around the neck portion 14.

As best shown in FIG. 1, a sheet of resilient material 24 is wrapped around the padding material 22 and the core 12. The resilient material 24 can be made from foam padding, neoprene, or other suitable materials. The resilient material 24 provides additional padding around the core 12 and helps to distribute the force imposed upon the core 12 by the animal's chewing. The resilient material 24 can be sized so that it covers the body of the core 12 and the neck portion 14, as shown in FIG. 1.

An inner cover 26 is provided around resilient material 24. The inner cover 26 is a durable fabric material and is preferably a durable nylon woven fabric. An outer shell 28 is provided around the inner cover 26 and encloses the inner cover 26, resilient material 24, padding 22, and core 12. The outer shell 28 includes end portions 30 and 32 to enclose the inner components of the pet toy 10. The outer shell 28 is wrapped around the inner components of the toy and stitched along its ends to form a tube. Circular end portions 30 and 32 are stitched to the ends of the tube. The outer shell 28 is a durable fabric material and is preferably a durable nylon woven fabric. The outer shell 28 fabric preferably has a tighter, finer knit/weave to help prevent the penetration of dirt. The outer shell 28 includes an inner surface coating that provides a moisture barrier to help keep excess moisture, including animal saliva, from saturating the inner components of the pet toy. The outer shell 28 can include a coating layer of polyurethane, or other suitable material, on its inner surface to provide a suitable moisture barrier.

In another embodiment of the pet toy, the resilient material 24 can be wrapped around the core 12 without the padding material 22 therebetween. The resilient material 24 is applied around the core 12 and secured thereto by use of tape, adhesive, or other suitable means. The resilient material 24 is dimensioned so that it is long enough to wrap around the core 12 but its width is such that it does not cover the neck portion 14 of the core 12. Padding material 22 is provided around the neck portion 14 of the core 12 and is disposed between the neck portion 14 and the inner cover 26. The outer cover 28 encloses the inner components of the pet toy.

Having described embodiments of the invention with reference to the accompanying drawings, it is to be understood that the invention is not limited to those precise embodiments, and that various changes and modifications may be effected therein by one skilled in the art without departing from the scope or spirit of the invention.

1. A noise making animal toy, comprising:
a sealed vessel having a resilient wall that can be deformed when pressure is applied to the toy;
at least a portion of the vessel wall is formed so that it bends in and out to form a textured surface, wherein the deformation of the wall of the vessel by application of force produces a noise; and
an outer durable fabric shell enclosing the vessel.

2. A noise making animal toy according to claim 1, further comprising:
a sheet of resilient material being provided around at least a portion of the vessel, and being disposed between the outer durable fabric shell and the vessel.

3. A noise making animal toy according to claim 1, wherein the vessel is made from a durable resilient material.

4. A noise making animal toy according to claim 1, wherein the vessel is a plastic beverage bottle.

5. A noise making animal toy according to claim 1, further comprising:
a bell disposed within the vessel.
